(19) United States
(12) Patent Application Publication
(10) Pub. No.: US 2009/0276285 A1
(43) Pub. Date: Nov. 5, 2009

(54) SEARCH ENGINE TO BROKER ADVERTISER WITH PUBLISHER

(75) Inventor: Jagadeshwar Reddy Nomula, Sunnyvale, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/114,112

(22) Filed: May 2, 2008

(51) Int. Cl. G06Q 10/00; G06F 17/30

(52) U.S. Cl. 705/10

(57) ABSTRACT

A method for brokering advertisers and publishers includes crawling internet websites to extract information from publisher websites including at least one of keywords, tags, images, digital media, or combinations thereof, collecting browser activity data as monitored from users browsing the websites; reverse indexing the publisher information in relation to corresponding browser activity data in a database according to a plurality of attributes included in the browser activity data; and enabling advertisers to keyword search the reversed indexed information through a search web server that is coupled with the database, wherein the search web server returns relevancy-based search results together with publisher information that enables the advertisers to contact the publishers regarding purchasing advertising inventory on publisher websites.

### BACKGROUND

1. Technical Field

The disclosed embodiments relate to a system and methods to provide advertiser access to a search engine that brokers advertising inventory purchase by an advertiser on a publisher web page.

2. Related Art

Internet advertising is a multi-billion dollar industry and is growing at double digits rates in recent years. It is also the major revenue source for internet companies, such as Yahoo! of Sunnyvale, Calif. or Google of Mountain View, Calif., which provide advertising networks that connect advertisers, publishers, and Internet users. A major portion of revenue has historically come from sponsored search advertisements and other advertising related to search through search engines, for instance. Another major source of revenue includes serving advertisements to web pages that include content matching material related to the advertisement.

Currently, advertisers have no efficient way of searching for publishers with specific advertising inventory on websites that would match up well with the advertisements the advertisers seek to place. Advertising inventory refers to free space available for specific types of ads that advertisers are willing to pay the publishers for display thereof on their websites. Historically, such searching must be done in the conventional way, namely by using a regular search engine, such as those provided by Yahoo! and Google, for instance. This may not be very effective, however, because search engines will return anything relevant and, therefore, usually includes thousands of websites. Advertisers have no way of knowing which of those websites are commercial, are willing to sell advertising inventory, or even if they are commercial and sell advertising inventory, whether there is any excess inventory for purchase at the time. Furthermore, results are not always relevant enough to be sufficiently related to the advertisements of the advertiser.

Placing advertisements on web pages with relevant content allows advertisers to better target users that are more likely to be interested in the subject matter of their offered goods or services. Accordingly, by being able to partner with publishers that offer targeted web pages for service of related advertisements, advertisers may obtain better results per advertising dollar, or in other words, they increase their return on investment (ROI).

### SUMMARY

By way of introduction, the embodiments described below are drawn to a system and methods to provide advertiser access to a search engine that brokers advertising inventory purchase by an advertiser on a publisher web page.

In a first aspect, a method is disclosed for brokering advertisers and publishers that includes crawling internet websites to extract information from publisher websites including at least one of keywords, tags, images, digital media, or combinations thereof; collecting browser activity data as monitored from users browsing the websites; reverse indexing the publisher information in relation to corresponding browser activity data in a database according to a plurality of attributes included in the browser activity data; and enabling advertisers to keyword search the reversed indexed information through a search web server that is coupled with the database. The search web server returns relevancy-based search results together with publisher information that enables the advertisers to contact the publishers regarding purchasing advertising inventory on publisher websites.

In a second aspect, a method is disclosed for brokering advertisers and publishers that includes crawling internet websites to extract information from publisher websites including at least one of keywords, tags, images, digital media, or combinations thereof; collecting browser activity data as monitored from users browsing the websites; reverse indexing the publisher information in relation to corresponding browser activity data in a database according to a plurality of attributes included in the browser activity data; and enabling an advertiser to keyword search the reversed indexed information through a search web server that is coupled with the database, wherein the search web server returns relevancy-based search results, including at least one publisher having a relevant website, together with contact information of an advertiser broker. The advertiser broker brokers an advertising agreement between the advertiser and the at least one publisher and charges the advertiser and the at least one publisher a fee.

In a third aspect, a system is disclosed for brokering advertisers and publishers that includes a crawler server operable to crawl internet websites to extract information from publisher websites including at least one of keywords, tags, images, digital media, or combinations thereof. An analytics server is operable to collect browser activity data as monitored from users browsing the websites. An indexer coupled with the crawler and the analytics server is operable to reverse index the publisher information in relation to corresponding browser activity data in a database according to a plurality of attributes included in the browser activity data. A search web server coupled with the indexer is operable to enable advertisers to keyword search the reversed indexed information stored in the database. A processor of the search web server returns relevancy-based search results together with publisher information that enables the advertisers to contact the publishers regarding purchase of advertising inventory.

In a fourth aspect, a search engine to broker advertising between advertiser and publishers includes a memory to store instructions of a web-based search engine. A database stores indexed publisher information and corresponding browser activity data. An interface is operatively coupled with the database and memory to communicate with advertisers that seek publishers with whom to advertise. A processor is operatively coupled with the memory and the interface, wherein the processor ensures the integration of the interface with the database, and is operable to: crawl websites to extract the publisher information including at least one of keywords, tags, images, digital media, or combinations thereof; collect the browser activity data as monitored from users browsing the websites; reverse index the publisher information in relation to corresponding browser activity data in the database according to a plurality of attributes included in the browser activity data; and enable advertisers to keyword search the reversed indexed information through the interface.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is a diagram of an exemplary system for brokering advertising between advertisers and publishers through a search web server and indexer made available to advertisers.

FIG. 2 is a flow diagram that provides an overall flow of the methods explained herein that extracts and saves publisher information and user-monitored data, indexes them in relation to each other, and makes the indexed information available to advertisers through the search web server of FIG. 1.

FIG. 3 is a flow chart of an exemplary method for brokering advertising between advertisers and publishers.

### DETAILED DESCRIPTION

By way of introduction, the disclosed embodiments relate a system and methods to provide advertiser access to a search engine that brokers advertising inventory purchase by an advertiser on a publisher web page. Accordingly, advertisers may more easily locate potential, relevant publisher advertising inventory being offered by publishers for display of their advertisements.

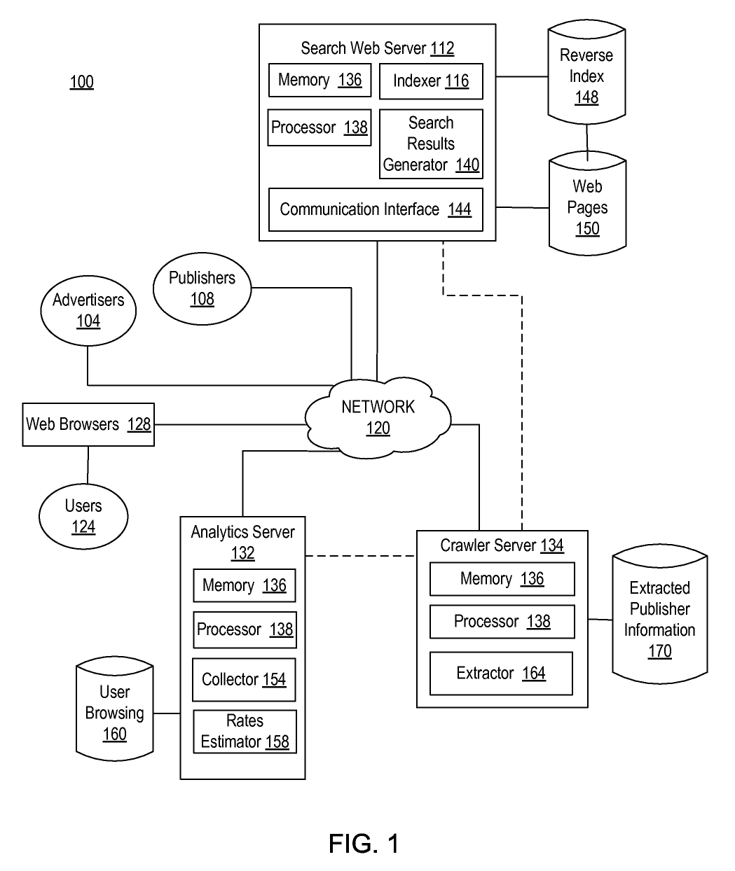

FIG. 1 is a diagram of an exemplary system 100 for brokering advertising between advertisers 104 and publishers 108 through a search web server 112 and an indexer 116 made available to advertisers 104 over a network 120. The network 104 may include the internet or World Wide Web (“Web”), a wide area network (WAN), a local area network (“LAN”), and/or an extranet, connected to through use of either a wired or wireless connection. One or more users 124 may access, through the network 120, the search web server 112 through web browsers 128 on their communication devices (not shown).

The system 100 may further include, in addition to the search web server 112 (herein variably referred to as the search engine 112), an analytics server 132 and a crawler server 134. The search web server 112 may include the indexer 116 or the indexer may be executed remotely on another computing device, and be coupled with the web search server 112 over the network 120. Herein, the phrase “coupled with” is defined to mean directly connected to or indirectly connected through one or more intermediate components.

The search web server 112 may further include a memory 136 to store computer code or instructions, a processor 138 to execute the computer code or instructions, a search results generator 140, a communication interface 144, a reverse index database 148, and a web pages database 150. Note that “web pages” and “websites” are intended to be synonymous as used herein. The analytics server 132 may further include a memory 136, a processor 138, a collector 154, a rates estimator 158, and a user browsing database 160. The crawler server 134 may further include a memory 136, a processor 138, an extractor 164, and an extracted publisher information database 170.

The search web server 112, the analytics server 132, and the crawler server 134 are all coupled with each other, and as indicated by the dashed line, may in fact be included within the same server (or search engine 112) or directly connected together. The crawler server 134 communicates over the network 120 to crawl through websites on the internet 120 (and/or on an intranet or extranet given the proper permissions) to gather publisher information. As the crawler server 134 crawls, the extractor extracts specific keywords, tags, images, digital media, and other helpful content to assess and track the subject matter of publisher websites. The publisher information is saved in the extracted publisher information database 170.

The collector 154 of the analytics server 132 monitors visitors to at least some of the above-referenced publisher websites to collect information about visitors to each respective website. An example of an application such as the collector 154 is Alexa Internet of Alex Internet, Inc., a subsidiary of Amazon.com. Alexa provides information on web traffic to other websites, and comes as a browser tool bar to monitor internet activity of users 124. Monitored internet activity of users includes how many visit each monitored website, and from where did the visitors come (some of which may come from diverse data sources). Such monitored information may be used to produce rankings of websites.

The traffic rank is based on three months of aggregated historical traffic data from millions of Alexa Toolbar users 124 and data obtained from other, diverse traffic data sources, and is a combined measure of page views and users (reach). As a first step, Alexa computes the reach (or percentage of all users 124 that visit the site) and number of page views for all sites on the Web on a daily basis. Pages views are the number of pages viewed by site visitors. The main Alexa traffic rank is based on a value derived from these two quantities averaged over time (so that the rank of a site reflects both the number of users 124 who visit that site as well as the number of pages on the site viewed by those users). The three-month change is determined by comparing the site's current rank with its rank from three months ago. For example, on July 1, the three-month change would show the difference between the rank based on traffic during the first quarter of the year and the rank based on traffic during the second quarter.

There exists some controversy over how representative Alexa's user base is of typical internet behavior because it largely gathers data through those users 124 that have their toolbar installed on their web browser 128. Accordingly, Alexa's rankings are not always a random sample of sufficient size or representative of a fair cross section of global internet users 124. The analytics server 132 of the present application may collect traffic data as does Alexa, or may do so in a more representative way to include web traffic passively collected that comes from sources outside of the Alexa (or similar) toolbar. Such passive methods may include crawler technology such as known to those of skill in the art.

The rates estimator 158 of the analytics server 132 may calculate expected advertising rates on a cost-per-mille (CPM), or in other words, cost per thousand (CPT). That is, what does it cost an advertiser per 1,000 views of its advertisement. If the total cost for running an advertisement is $15,000, and if the total views is 2,400,000, than CPM is calculated to be $6.25. The hottest advertising venues attract the highest CPM. The rates estimator 158 may also calculate “effective” CPM (eCPM), which measures the effectiveness of a publisher's inventory being sold via cost per advertisement (CPA), cost per click (CPC), or a CPT basis. In other words, eCPM tells the publisher 108 what they would have received if they sold the advertising inventory on a CPM basis (instead of a CPA, CPC, or CPT basis).

The indexer 116, which as discussed may be a part of the search web server 112, then indexes the user browsing information from database 160 together with the extracted publisher information in database 170 in the reverse index database 148 based on keywords, CPM/eCPM, user demographics, and other relevant attributes culled from data taken from each respective website. The web pages to which the index relates may be stored in the web pages database 150, which may be joined physically or logically with the reverse index database 148 as a single database.

The search web server 112 communicates through the communication interface 144 with the advertisers 104, the publishers 108, and the users 112. The communication interface 144 may also expose the reverse index database 148 to the advertisers 104 via a web front end using hypertext markup language (HTML), which can be used by the advertisers 104 to search for publisher advertising inventory. When an advertiser 104 enters a keyword in a web page coupled with the communication interface 144, the search web server 112, together with its memory 136 and processor 138, searches the reverse index database 148 to find content relevant to the keyword. The keyword may be relevant to the extracted publisher information obtained through crawling and/or to user browsing information related to monitored visitor traffic. Accordingly, a searching advertiser 104 may locate a publisher website having relevant one or more: keywords or keyword types, tags, images, digital media, other media, traffic volume, CPM, eCPM, user demographics, location of target audience, or combinations thereof. The search engine 112 interface may include a specific uniform resource locator (URL) that makes available the HTML web front end.

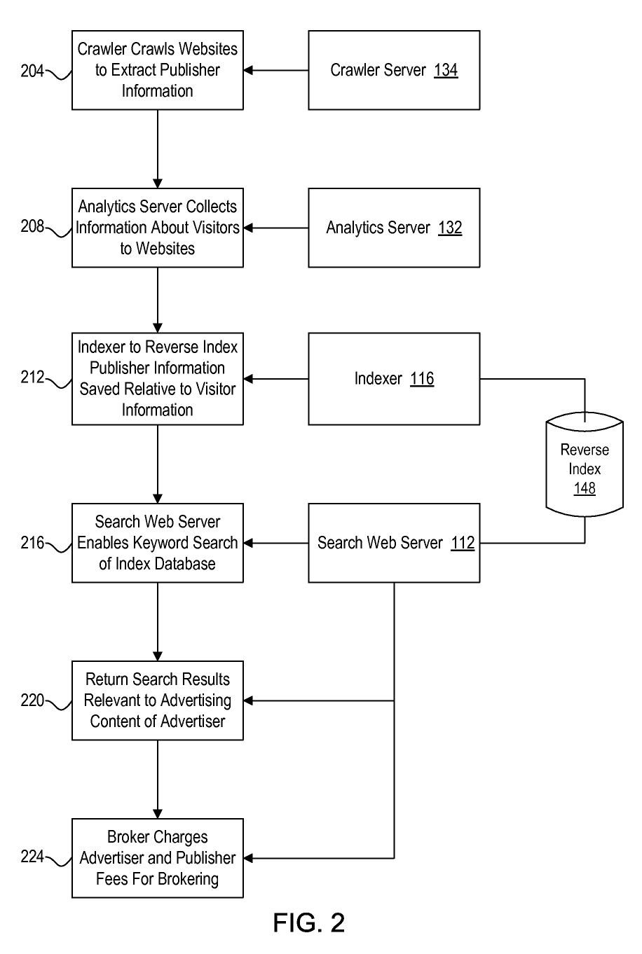

FIG. 2 is a flow diagram that provides an overall flow of the methods explained herein that extracts and saves publisher information and user-monitored data, indexes them in relation to each other, and makes the indexed information available to advertisers 104 through the search web server 112 of FIG. 1. The method, at block 204, uses the crawler server 134 to crawl websites to extract information from publisher websites as discussed above. At block 208, the method uses the analytics server 132 to collect information about visitor traffic to the at least some of the same websites. At block 212, the indexer 116 reverse indexes the publisher information in relation to the visitor traffic information, in addition to retaining links to the original publisher website from which the crawler obtained the publisher information. This allows storing, in the reverse index database 148, contact information of the publishers that own the websites saved in relation to the publisher information.

At block 216, the method enables an advertiser to access the search web server 112 to perform keyword searches that are conducted on the reverse index database 148. Because the reverse index database 148 is coupled with the web pages database 150, the publisher contact information may be made available together with the search results whenever available. At block 220, the search web server 112 returns the search results relevant to the keyword, which includes a hierarchal list of publisher websites and related contact information, if available. In some embodiments, the advertisers 104 may restrict the search results returned to only those publisher websites that have relevant, excess advertising inventory available. The advertiser may then contact the publisher having desired advertising inventory to purchase the same.

In some embodiments, at block 224, an advertising broker such as Yahoo! of Sunnyvale, Calif. owns and operates the search web server 112, and charges both the publisher 108 and the advertiser 104 upon brokering an advertising inventory purchase or contract between the two. Once an agreement is set, whether through purchase or agreement, the advertiser 104 sends an advertisement and related creative to the publisher 108 for service to the publisher's website. The advertisement may be a simple display creative or a URL hosted creative. Such a system 100 set up by an advertiser broker may allow the advertiser broker to obtain more advertisers 104 and potentially present more advertising solutions during the process of advertisement discovery by users 124.

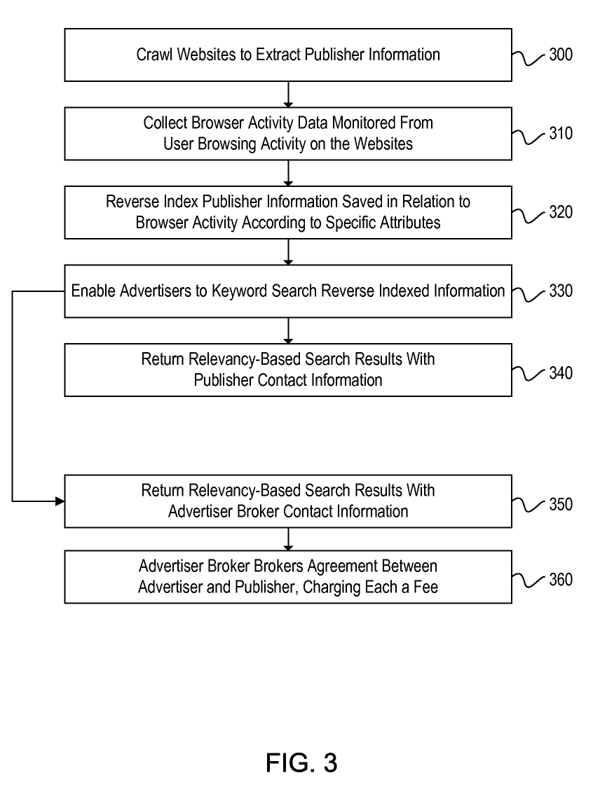

FIG. 3 is a flow chart of an exemplary method for brokering advertising between advertisers 104 and publishers 108. The method, at block 300, crawls internet websites to extract information from publisher websites including at least one of keywords, tags, images, digital media, and combinations thereof. At block 310, it collects browser activity data as monitored from users 124 browsing the websites. At block 320, it reverse-indexes the publisher information in relation to corresponding browser activity data in a database according to a plurality of attributes included in the browser activity data. At block 330, it enables advertisers 104 to keyword search the reversed indexed information through a search web server that is coupled with the database. At block 340, the search web server 112 returns relevancy-based search results together with publisher information that enables the advertisers 104 to contact the publishers 108 regarding purchasing advertising inventory on publisher websites.

In some embodiments, at block 350, the search web server 112 is owned by an advertiser broker that returns, with the relevancy-based search results, contact information of the advertiser broker that then facilitates brokering an advertising agreement between the advertiser 104 and the publisher 108. At block 360, the advertiser broker charges the advertiser 104 and at least one publisher a fee for brokering the advertising agreement between the same.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superceding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

In the foregoing description, numerous specific details of programming, software modules, user selections, network transactions, database queries, database structures, etc., are provided for a thorough understanding of various embodiments of the systems and methods disclosed herein. However, the disclosed system and methods can be practiced with other methods, components, materials, etc., or can be practiced without one or more of the specific details. In some cases, well-known structures, materials, or operations are not shown or described in detail. Furthermore, the described features, structures, or characteristics may be combined in any suitable manner in one or more embodiments. The components of the embodiments as generally described and illustrated in the Figures herein could be arranged and designed in a wide variety of different configurations.

The order of the steps or actions of the methods described in connection with the disclosed embodiments may be changed as would be apparent to those skilled in the art. Thus, any order appearing in the Figures, such as in flow charts, or in the Detailed Description is for illustrative purposes only and is not meant to imply a required order.

Several aspects of the embodiments described are illustrated as software modules or components. As used herein, a software module or component may include any type of computer instruction or computer executable code located within a memory device and/or transmitted as electronic signals over a system bus or wired or wireless network. A software module may, for instance, include one or more physical or logical blocks of computer instructions, which may be organized as a routine, program, object, component, data structure, etc. that performs one or more tasks or implements particular abstract data types.

In certain embodiments, a particular software module may include disparate instructions stored in different locations of a memory device, which together implement the described functionality of the module. Indeed, a module may include a single instruction or many instructions, and it may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

Various modifications, changes, and variations apparent to those of skill in the art may be made in the arrangement, operation, and details of the methods and systems disclosed. The embodiments may include various steps, which may be embodied in machine-executable instructions to be executed by a general-purpose or special-purpose computer (or other electronic device). Alternatively, the steps may be performed by hardware components that contain specific logic for performing the steps, or by any combination of hardware, software, and/or firmware. Embodiments may also be provided as a computer program product including a machine-readable medium having stored thereon instructions that may be used to program a computer (or other electronic device) to perform processes described herein. The machine-readable medium may include, but is not limited to, floppy diskettes, optical disks, CD-ROMs, DVD-ROMs, ROMs, RAMs, EPROMs, EEPROMs, magnetic or optical cards, propagation media or other type of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

1. A method for brokering advertisers and publishers, the method comprising:
crawling internet websites to extract information from publisher websites comprising at least one of keywords, tags, images, digital media, or combinations thereof;
collecting browser activity data as monitored from users browsing the websites;
reverse indexing the publisher information in relation to corresponding browser activity data in a database according to a plurality of attributes included in the browser activity data; and
enabling advertisers to keyword search the reversed indexed information through a search web server that is coupled with the database, wherein the search web server returns relevancy-based search results together with publisher information that enables the advertisers to contact the publishers regarding purchasing advertising inventory on publisher websites.

2. The method of claim 1, wherein collecting browser activity data further comprises:
calculating expected advertising rates on a cost-per-thousand (CPM) or an effective CPM (eCPM) basis based on known statistics on similar websites.

3. The method of claim 2, wherein the plurality of attributes comprises at least one of keywords, keyword types, CPM, eCPM, user demographics, or combinations thereof.

4. The method of claim 1, further comprising:
enabling the advertiser to restrict the search results to only those publisher websites that have excess advertising inventory.

5. The method of claim 1, wherein a broker owns the database and the search web server, and wherein a publisher accepts at least one advertisement of a searching advertiser to be displayed on a website of the publisher, the method further comprising:
the broker charging the advertiser and the publisher for brokering the at least one advertisement.

6. A system for brokering advertisers and publishers, the system comprising:
a crawler server operable to crawl internet websites to extract information from publisher websites comprising at least one of keywords, tags, images, digital media, or combinations thereof;
an analytics server operable to collect browser activity data as monitored from users browsing the websites;
an indexer coupled with the crawler and the analytics server operable to reverse index the publisher information in relation to corresponding browser activity data in a database according to a plurality of attributes included in the browser activity data; and
a search web server coupled with the indexer operable to enable advertisers to keyword search the reversed indexed information stored in the database, wherein a processor of the search web server returns relevancy-based search results together with publisher information that enables the advertisers to contact the publishers regarding purchase of advertising inventory.

7. The system of claim 6, wherein the analytics server is operable to calculate expected advertising rates on a cost-per-thousand (CPM) or an effective CPM (eCPM) basis based on known statistics on similar websites.

8. The system of claim 7, wherein the plurality of attributes comprises at least one of keywords, keyword types, CPM, eCPM, user demographics, or combinations thereof.

9. The system of claim 6, wherein the search web server enables the advertiser to submit keywords related to a subject matter of their business for which they seek advertising inventory space.

10. The system of claim 6, wherein a publisher accepts at least one advertisement of a searching advertiser to be displayed on a website of the publisher, wherein the search web server charges the advertiser and the publisher for brokering the at least one advertisement.

11. A search engine to broker advertising between advertiser and publishers, the search engine comprising:
a memory to store instructions of a web-based search engine;
a database to store indexed publisher information and corresponding browser activity data;
an interface operatively coupled with the database and memory to communicate with advertisers that seek publishers with whom to advertise;
a processor operatively coupled with the memory and the interface, wherein the processor ensures the integration of the interface with the database, and is operable to:
crawl websites to extract the publisher information comprising at least one of keywords, tags, images, digital media, or combinations thereof;
collect the browser activity data as monitored from users browsing the websites;
reverse index the publisher information in relation to corresponding browser activity data in the database according to a plurality of attributes included in the browser activity data; and
enable advertisers to keyword search the reversed indexed information through the interface.

12. The search engine of claim 11, wherein the processor returns relevancy-based search results together with publisher information to the user through the interface, wherein the publisher information enables the advertisers to contact the publishers regarding advertising on websites of the publishers.

13. The search engine of claim 12, wherein the processor enables the advertiser to submit keywords related to a subject matter of their business for which they seek advertising inventory space.

14. The search engine of claim 12, wherein the interface is operable to communicate with the publishers, one of the publishers accepts at least one advertisement of a searching advertiser to be displayed on a website of the publisher, and wherein the processor charges the advertiser and the publisher for brokering the at least one advertisement.

15. The search engine of claim 11, wherein the processor is operable to calculate expected advertising rates on a cost-per-thousand (CPM) or an effective CPM (eCPM) basis based on known statistics on similar websites.

16. The search engine of claim 15, wherein the plurality of attributes comprises at least one of keywords, keyword types, CPM, eCPM, user demographics, or combinations thereof.

17. A method for brokering advertisers and publishers, the method comprising:
crawling internet websites to extract information from publisher websites comprising at least one of keywords, tags, images, digital media, or combinations thereof;
collecting browser activity data as monitored from users browsing the websites;
reverse indexing the publisher information in relation to corresponding browser activity data in a database according to a plurality of attributes included in the browser activity data; and
enabling an advertiser to keyword search the reversed indexed information through a search web server that is coupled with the database, wherein the search web server returns relevancy-based search results, including at least one publisher having a relevant website, together with contact information of an advertiser broker;
wherein the advertiser broker brokers an advertising agreement between the advertiser and the at least one publisher and charges the advertiser and the at least one publisher a fee.

18. The method of claim 17, further comprising:
the advertiser broker serving an advertisement of the advertiser to a website of the at least one publisher having content relevant to the advertisement.

19. The method of claim 18, wherein the contact information further comprises automated means of communicating with the advertiser broker.

20. The method of claim 17, further comprising:
enabling the advertiser to restrict the search results to only those publisher websites that have excess advertising inventory.
